(19) United States
(12) Patent Application Publication
(10) Pub. No.: US 2008/0217237 A1
(43) Pub. Date: Sep. 11, 2008

(54) Spin-On Filter with Base Plate and Gasket and Method of Assembly Thereof

(75) Inventors: Dennis Michael Deedrich, Champaign, IL (US); Randall William Heibenthal, Mahomet, IL (US)

Correspondence Address: MERCHANT & GOULD PC, P.O. BOX 2903, MINNEAPOLIS, MN, 55402-0903, US

(73) Assignee: ADVANCED FILTRATION SYSTEMS, INC., CHAMPAIGN, IL (US)

(21) Appl. No.: 11/578,280

(22) PCT Filed: Aug. 10, 2004
(86) PCT No.: PCT/US04/25817

§ 371 Date: Sep. 10, 2007

Related U.S. Application Data
(60) Provisional application No. 60/562,131, filed on Apr. 13, 2004.

(51) Int. Cl. B23P 11/00; B01D 35/02

(52) U.S. Cl. 210/444; 29/428

(57) ABSTRACT

Baffle plate and gasket arrangements are provided. The arrangements include a baffle plate (60) and gasket (104). Preferred arrangements include the baffle plate (60) having an outer peripheral sidewall (64) defining a gasket seat, with a gasket mounted within the seat such that an axial seal is formed against an appropriately positioned structure on a housing can. Housing arrangements for fluted filter arrangements include a can, a baffle plate, and a gasket. The gasket is mounted with respect to the baffle plate and the can to form an axial seal between the can and the baffle plate. Filter arrangements including a housing of the type characterized and a filter cartridge operably mounted therein. In addition, methods of assembly and use are provided.

### CROSS-REFERENCE TO RELATED PROVISIONAL APPLICATION

The current application includes disclosure from, and is related to, Provisional Application 60/562,131 filed Apr. 13, 2004. The complete disclosure of 60/562,131 is incorporated herein by reference and entitlement to the priority of 60/562,131 is claimed, as appropriate.

### TECHNICAL FIELDS

This disclosure generally concerns fluid filters. In particular, this disclosure relates to filters incorporating an improved seal arrangements.

### BACKGROUND

Filters have been employed in a variety of applications including fuel systems, hydraulic systems and engine lubrication systems. Such filter assemblies generally include a cylindrical filter element within a can or housing with a baffle or attachment plate at one end to connect the filter to a filter head, typically by a threaded joint. A central opening and several surrounding openings in the baffle direct flow through the filter and, in particular, the filter element. The flow can be in either an inside-out (forward flow) or an outside-in (reverse flow) pattern. A gasket serves as a seal between the baffle and the can or housing. Continued improvements in filters are desired.

### SUMMARY OF THE DISCLOSURE

According to the present disclosure, baffle plate and gasket arrangements are provided. The arrangements include a baffle plate and a gasket. Preferred arrangements include the baffle plate having an outer peripheral side wall and defining a gasket seat, with a gasket mounted within the seat such that an axial seal is formed against an appropriately positioned structure on a housing can.

Housings for fluted filter arrangements are described which include a can, a baffle plate and a gasket. The gasket is mounted with respect to the baffle plate and the can to form an axial seal between the can and the baffle plate.

Filter arrangements are provided including a housing of the type characterized and a filter cartridge operably mounted therein.

A variety of features are disclosed for certain, exemplified, arrangements. There is no requirement that all of the disclosed features are present in an arrangement, for that arrangement to be improved according to the teachings of this disclosure.

In addition, methods of assembly and use are provided.

### BRIEF DESCRIPTION OF THE DRAWINGS

FIG. 1 is a perspective view of a baffle plate and gasket arrangement constructed according to principles of this disclosure;

FIG. 2 is a perspective view of the baffle plate depicted in FIG. 1, viewing an opposite side;

FIG. 3 is a schematic, cross-sectional view of the baffle plate and gasket arrangement depicted in FIG. 1, the cross-section being taken along the line 3-3 of FIG. 1;

FIG. 4 is a schematic, cross-sectional view of a filter assembly utilizing the baffle plate and gasket arrangement of FIGS. 1-3, the cross-section being taken along the line 4-4 of FIG. 6;

FIG. 5 is an enlarged, fragmented, schematic cross-sectional view of a portion of the filter assembly depicted in FIG. 4;

FIG. 5A is an enlarged, fragmented, schematic cross-sectional view of a portion of the gasket seat of the baffle plate depicted in FIGS. 1-5;

FIG. 6 is a schematic side elevational view of a filter assembly secured to a filter head, constructed according to principles of this disclosure;

FIG. 7 is a schematic, side elevational view of a system utilizing filter assemblies constructed according to principles of this disclosure;

FIG. 8 is a schematic, cross-sectional view of a filter assembly utilizing a first alternate baffle plate and gasket arrangement according to the present disclosure; the cross-section of FIG. 8 being analogous to FIG. 4.

FIG. 9 is an enlarged, fragmentary view of a portion of FIG. 8; FIG. 9 showing, among other things, a portion of a baffle plate analogously to FIG. 3.

FIG. 10 is a schematic, cross-sectional view of a filter assembly utilizing a second, alternate baffle plate and gasket arrangement according to the present disclosure; the cross-section being taken generally analogous to FIGS. 4 and 8; and,

FIG. 11 is an enlarged, fragmentary view of a portion of FIG. 10; FIG. 11 showing, among other things, a portion of a baffle plate analogously to FIG. 9.

### DETAILED DESCRIPTION

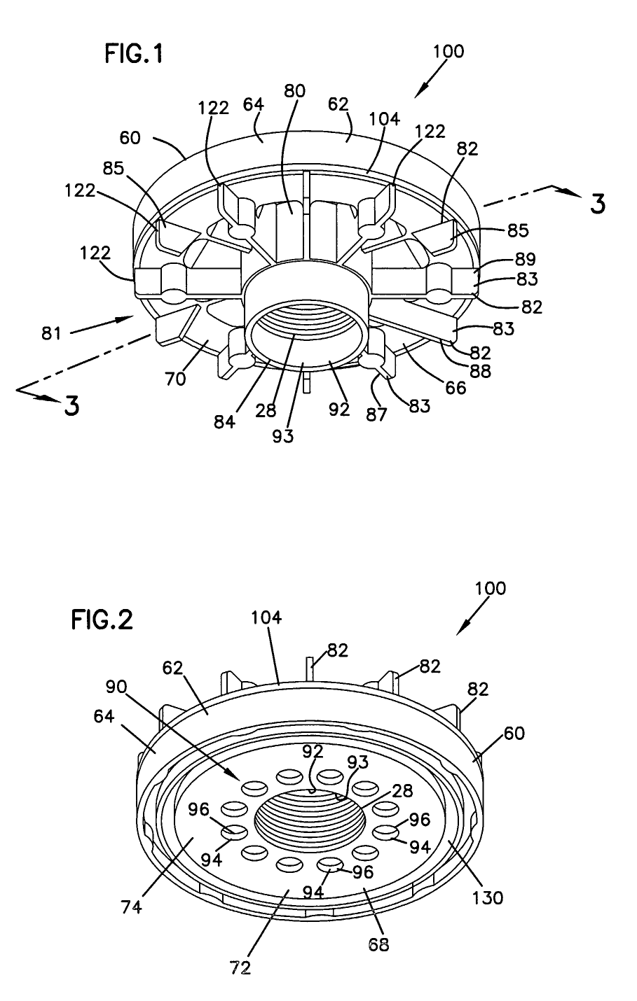

### A. Overall Assembly; Systems of Use—FIGS. 1-7

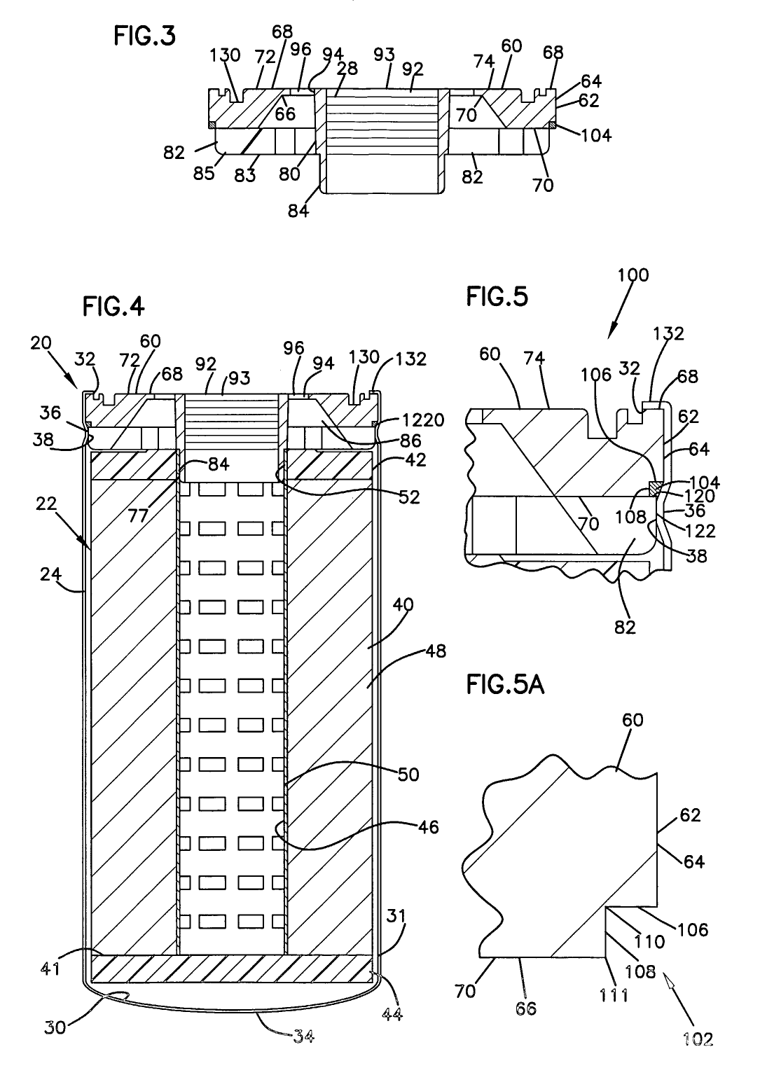

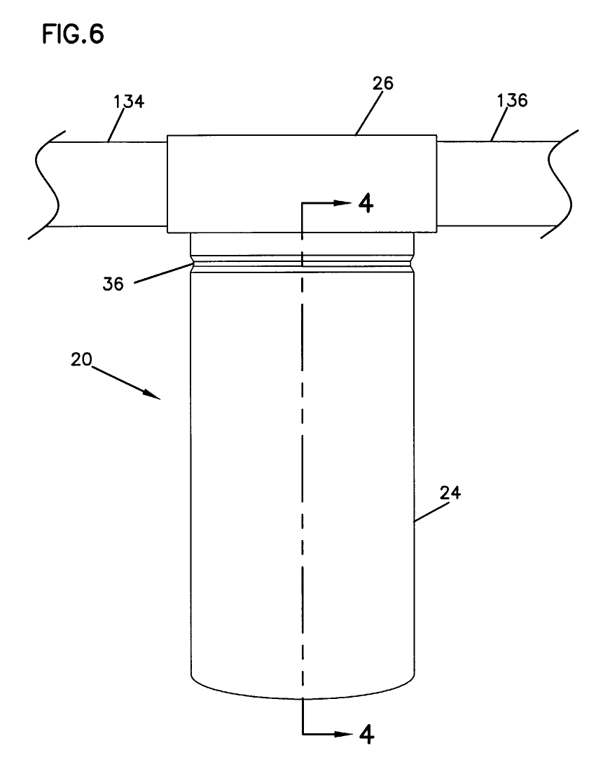

Referring first to FIG. 6, there is illustrated a fluid filter assembly 20. Filter assembly 20 is particularly adapted for filtration of liquid, for example oil, fuel or hydraulic fluid, as for example in a hydrostatic transmission or other hydraulic system. The filter assembly 20 includes a filter cartridge or element 22 (FIG. 4) operably oriented in a can 24. The filter assembly 20 is operably mounted to a filter block or filter head 26 (FIG. 6), typically by screwing the filter assembly 20 onto the filter head 26 by internal threads 28 (FIG. 3) on the filter assembly 20.

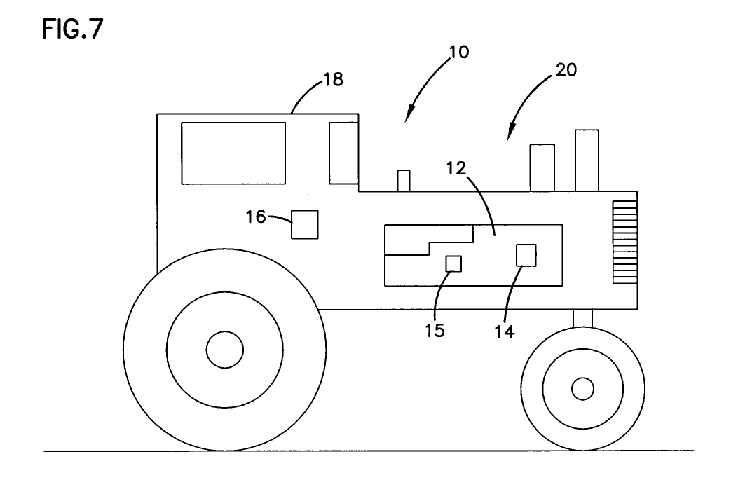

Attention is next directed to FIG. 7. FIG. 7 is a schematic depiction of equipment 10 including an engine 12. The equipment 10 includes a lubrication system 14, a fuel system 15, and a hydraulic system 16. The lubrication system 14, the fuel system 15, and the hydraulic system 16 will need to have a fluid in the system (oil, fuel, or hydraulic fluid) cleaned; i.e., filtered. To provide the cleaning function, a fluid filter assembly is utilized. In the example embodiment shown in FIG. 7, there are three fluid filter assemblies 20 shown, one for the lubrication system 14, one for the fuel system 15, and one for the hydraulic system 16. Equipment 10 shown in FIG. 7 can be a tractor 18. The fluid filter assembly 20 is useable with other types of equipment including, but not limited to, bulldozers, skid steers, payloaders, mining equipment, over-the-highway trucks, off-road trucks, combines, and other types of equipment, including industrial filtration, generators, and any system with an engine or hydraulic system.

For the systems described herein, mobile hydraulic filters will have operating pressures generally between −7 psi and 700 psi. Operating pressures for an engine lube system will be 40 psi-80 psi, with compressor lube systems being about 250 psi. For fuel systems, if the pressure is on the upstream side of the pump, it will be under vacuum pressure of about −10 psi. If used as a secondary filter, on the downstream side of the pump, the operating pressures will be 60 psi. In industrial hydraulic applications, the pressures are generally high, such as up to 6,000 psi. Of course, the pressures can vary, and these are simply examples.

In reference now to FIG. 4, the filter assembly 20 includes the filter cartridge 22 operably oriented within the can 24. The filter can 24 has an interior volume 30 designed to accept the filter cartridge 22 therein. The filter can 24 generally has a surrounding wall 31 defining an open first end 32 and a closed second end 34. Preferably, the can wall 31 is of a fairly thin construction having sufficient rigidity to withstand the pressure experienced during typical filtering operations. Can 24 is typically metal, plastic, or other suitable metal; if can 24 is metal, it is typically formed by stamping or drawing from the metal.

The can wall 31 includes an inner circumferential projection or shelf, in this instance bead 36. The bead 36 cooperates with other portions of the filter assembly 20 to seal the filter cartridge 22 there within. In the embodiment shown, the bead 36 includes a projection 38 extending or projecting into the interior volume 30 of the can 24. In preferred embodiments, the bead 36 is adjacent to the open end 32 and circumscribes the can interior 30, along the can wall 31. In preferred embodiments, the projection 38 extends a radial distance about 1-3 mm (typically about 1.7 mm) into the interior 30 from an outermost portion of the can 24 and has a length of about 3-12 mm (typically about 4-10 mm). Preferred implementations for the manner in which the bead 36 interacts with other portions of the filter assembly 20 are described further below.

The filter cartridge 22 is located inside the interior volume 30. The filter cartridge 22 includes a filtering material 40 for removing contaminants, such as particulate, from the fluid being filtered. Filtering material 40 extends from, and is potted within, a first end cap 42 and a second end cap 44. Filtering material 40 defines an open interior volume 46. Typically, the filtering material 40 is material such as a non-woven media formed from cellulosic fibers, synthetic fibers or mixtures thereof The filter material 40 may be treated or coated to improve its filtering capabilities.

In the one shown, the filter material 40 includes filter media 48 that is generally a pleated, porous material, such as paper. A perforated tubular inner liner 50 can be included in the filter cartridge 22. The inner liner 50 is surrounded by the filter media 48 and typically extends between the first and second end caps 42, 44.

The first end cap 42 is an open end cap and includes an aperture opening 52 therein. The opening 52 receives, circumscribes, and surrounds a portion of a baffle plate 60. The baffle plate 60 is secured across the open end 32 of the can 24. The second end cap 44, in the one shown, is a closed end cap that extends across and covers the end 41 of the filtering material 40 such that there cannot be access to the open interior volume 46 at end 41 of the filter cartridge 22.

The baffle plate 60 conveys filtered liquid from the filter assembly 20 and provides a barrier that prevents the bypass of unfiltered liquid around the filtering material 40. The baffle plate 60 includes an outer, peripheral edge 62, that forms an outer circumferential sidewall 64 of the baffle plate 60. The sidewall 64 is also the outer radial surface of the baffle plate 60. The baffle plate 60 also includes a first axial side 66, and an opposite second axial side 68, which, in the embodiment shown, also correspond to a bottom end surface 70 and a top end surface 72. The top end surface 72 corresponds to a top face 74. The outer peripheral sidewall 64 generally extends between the first axial side 66 and second axial side 68.

The baffle plate 60 defines a fluid flow aperture arrangement 90 (FIG. 2). The fluid flow aperture arrangement 90 permits the passage of fluid through the baffle plate 60 to provide communication between the filter cartridge 22 and filter head 26. Specifically, the fluid flow aperture arrangement 90 permits fluid flow communication with the interior volume 30 of the can 24. Depending on whether the filter assembly 20 is used in a forward flow system or in a reverse flow system, the aperture arrangement 90 can include apertures that are either inlet apertures or outlet apertures. For forward flow systems, the baffle plate 60 defines a central opening or aperture 92 that functions as an outlet aperture 93. Disposed around the central opening 92 is a plurality of apertures 94, which in forward flow systems, comprises inlet apertures 96.

The baffle plate 60 includes a hub 80, in particular, a central axially extending hub 80 that projects into the can 24 toward closed end 34. The particular hub 80 shown, is interconnected with fin arrangement 81. The fin arrangement 81 helps to space the filter cartridge 22 from the inlet apertures 96 to permit fluid flow to the filter cartridge 22. In the one shown, the fin arrangement 81 includes a plurality of radial webs, ribs, or fins 82. The hub 80 includes a neck 84 projecting from the first axial side 66. The fins 82, in the embodiment shown, also project from the first axial side 66. The fins 82 include a first fin set 83 and a second fin set 85. The first fin set 83 includes fins 82 that project or extend from the neck 84 toward the sidewall 64. The second fin set 85 includes fins 82 that extend only partially from the sidewall 64 toward the neck 84 and do not directly connect to the neck 84. In the particular example shown, the first fin set 83 and second fin set 85 alternate with each other, except for a portion of three of the first fin set 83 fins in a row, shown as fins 87, 88, and 89 (FIG. 1).

The hub 80 defines the central opening 92, extending through the baffle plate 60 and terminating inside the filter cartridge 22, in particular, inside the inner liner 50. Fluid passages 86 defined by the fins 82 and the surrounding neck 84 allow liquid to flow therethrough and into the interior volume 30 of the filter can 24. The cartridge 22 forms a seal 77 by radial force between the inner radial surface of the first end cap 42 and the neck 84. In some instances, an acrylic adhesive is used to enhance the seal.

Threads 28 are provided on the internal surface of the neck 84 for connecting the filter assembly 20 to the filter head 26 (FIG. 6). The neck 84 preferably extends below the fins 82 and into the opening 52 (FIG. 4) of the first end cap 42. In this manner, fluid flow communication is provided from the open filter interior 46 to the central opening 92 of the baffle plate 60.

In reference now to FIG. 5, a baffle plate and gasket arrangement 100 is depicted. The baffle plate and gasket arrangement 100 provides for engagement with the can 24 in order to seal the filter cartridge 22 within the filter assembly 20. In general, the baffle plate 60 includes a gasket seat 102 (FIG. 5A). The gasket seat 102 is for holding a gasket 104 into sealing engagement with the can 24. As will be explained below, in preferred arrangements, the seat 102 holds the gasket 104 in axially sealing engagement with the bead 36.

In reference now to FIG. 5A, in the preferred embodiment shown, the gasket seat 102 includes an axial seat surface 106 for supporting the gasket 104 in an axial direction. The axial seat surface 106, in the embodiment shown, is within a plane that is generally parallel to the planes that, generally, contain the first axial side 66 and second axial side 68 of the baffle plate 60. The axial seat surface 106, in the embodiment shown, is also generally orthogonal or normal to the peripheral sidewall 64.

In the embodiment shown, FIG. 5A, the seat 102 also includes a radial seat surface 108. The radial seat surface 108 is depicted in this embodiment as extending generally normal or perpendicular to the axial seat surface 106. The radial seat surface 108 provides a surface for resisting radially directing forces of the gasket 104. In the embodiment shown, the radial seat surface 108 is generally orthogonal or normal to the first axial side 66 and second axial side 68 of the baffle plate 60. The radial seat surface 108 defines first and second opposite ends 110, 111. The first end 110 is adjacent to and intersects the axial seat surface 106. At the second end 111, the gasket seat 102 is open and wall-free. By “wall-free”, it is meant that there are no other structures completely blocking access to the gasket 104 from the direction of the bottom end surface 70 of the baffle plate 60. In other words, the seat 102 axially accessible from only a single axial side; the seat 102 is not a U-shaped groove or C-shaped channel. In the orientation shown in FIG. 5A, the seat 102 is in the shape of a sideways L. The wall-free region of the seat 102 allows for axially directed forces from the can 24, in particular the bead 36, to reach the gasket 104 to provide an axial seal 120 (FIG. 5) between the baffle plate 60 and the bead 36 of the can 24. As can be seen in FIGS. 3 and 5, the gasket 104 is operably mounted within the gasket seat 104 against the axial seat surface 106 and against the radial seat surface 108. “Wall-free” allows for the extension of the ends of the fins 82, as explained in the next paragraph.

Attention is again directed to FIGS. 1, 3, and 5. As mentioned above, the fins 82 extend from the first axial side 66. Each of the fins has a free end 122, which is the end most adjacent to the sidewall 64. At least some of the fins 82, and in certain preferred embodiments, each of the fins 82 has its free end 122 extending adjacent or near the peripheral sidewall 64 of the baffle plate 60. In this manner, the free end 122 of each respective fin 82 overlaps a portion of the gasket 104. The overlap can be seen in the perspective view in FIG. 1. The overlap is not seen in FIG. 3 due to the angle and the area in which the cross-section was taken. The free ends 122 of the fins 82 do not extend completely to the baffle edge 62. Although alternatives are possible, in the arrangement shown, the free ends 122 are recessed from the baffle edge 62 by a distance of about 0.5-2 mm; and, the free ends 122 extend over the gasket seat 102 and gasket 104 by about 1-2 mm. As such, the gasket 104 is covered by the fins about 30-80% and exposed on the “wall-free” portion about 20-70%. The free ends 122 of the fins 82 help to trap the gasket 104 within the gasket seat 102. Although alternatives are possible, in the region where the fins 82 extend over the gasket 104, about 0.3-1.5 mm of the gasket 104 is exposed to axial forces and is “wall-free.” Of course, preferably in the region where fins 82 do not extend over the gasket 104, 100% (about 2.5 mm) of the gasket 104 is exposed to axial forces and is wall-free.

The free ends 122 of the fins 82, in certain preferred assemblies, engage and press into the bead 36. This can be see in FIGS. 4 and 5. This engagement helps to secure the baffle plate 60 into the can 24. The engagement between the bead 36 and fins 82 can be done either by forming the bead 36 in the can 24 first, and then press fitting the baffle plate 60 into the open end 32 of the can 24; or alternatively, orienting the baffle plate 60 into the open end 32 of the can 24 and then forming the bead 36 such that the axial seal 120 is formed between the gasket 104 and the bead 36 and the fins 82 engage the bead 36.

A variety of gaskets can be used for gasket 104. In preferred embodiments, the gasket 104 is a lathe cut gasket. By lathe cut, it is meant that the gasket is extruded from a suitable gasket material, such as rubber, and then sliced or cut into individual gaskets 104. Although alternatives are possible, the gasket 104 shown has an axial thickness of at least 1 mm, and typically about 1.5-3 mm, for example about 2 mm; and, the gasket typically has a radial thickness of about 2-3 mm, for example, about 2.5 mm. It typically has a hardness of about 55-65 Shore A, for example, about 60 Shore A.

In reference to FIG. 2, the top face 74 of the baffle plate 60 can be seen. The top face 74 includes a groove 130 for holding a face sealing gasket (not shown). The face sealing gasket forms a seal with the filter head 26 (FIG. 6), when the filter assembly 20 is secured into place on the filter head 26 in operable assembly. The face seal gasket typically has a hardness of about 60-80 Shore A, for example, about 70 Shore A. The can wall 31 includes an end flange 132. The end flange 132 defines the open end 32 of the can 24. The end flange 132 is oriented against the second axial side 68 of the baffle plate 60. Typically, in assembly, after the baffle plate 60 is oriented within the open end 32 of the can 24, the can wall 31 is formed to bend the wall 31 and form the end flange 132 to be in pressing engagement against the top face 74 or second axial side 68 of the baffle plate 60.

The filter assembly 20 works as follows: fluid to be filtered, such as liquid, enters the filter head 26 through an inlet conduit 134 (FIG. 6). The liquid is directed into the filter assembly 20 through the inlet apertures 96. The fins 82 provide space to allow for the liquid to flow through the passage 86 to reach the filter cartridge 22. The liquid to be cleaned is prevented from leaving the can 24 due to the existence of axial seal 120 between the baffle plate 60 and the can 24. The liquid then flows through the filter material 40 and into the open filter interior 46. The filter material 40 removes contaminants from the liquid. The filtered liquid then flows from the open filter material 46 into the outlet aperture 93 defined by the neck 84 of the hub 80. From there, the cleaned liquid exits the filter assembly and flows into the filter head 26. From the filter head 26, the cleaned liquid flows through an outlet conduit 136.

A method for assembling a filter arrangement is provided. The method includes inserting the filter cartridge 22 through the open end 32 and into the interior volume 30 of the can 24. The baffle plate 60 having the gasket 104 secured thereto is oriented to cover the open end 32 of the can 24. The axial seal 120 is formed by pressing the gasket 104 against the shelf or bead (axial seal surface) 36 of the can 24. The bead 36 can be either pre-formed in the can 24 before the baffle plate 60 is oriented, or the bead 36 can be formed into the can after the baffle plate 60 is placed over the open end 32.

The fins 82 and the bead 36 are pressed into engagement with each other to help hold the baffle plate 60 in place. The pressing can be done either by pressing the fins 82 into a pre-formed bead 36; or alternatively, forming the bead 36 into the can 24 to provide the pressing engagement therebetween.

Preferred methods also include bending the can 24 at the open end 32 to form the end flange 132 to press against the baffle plate 60. This helps to trap the filter cartridge 22 in place in the filter assembly 20 and also to press the gasket 104 into sealing engagement to form the axial seal 120.

In preferred methods, the step of orienting the baffle plate 60 further includes inserting the central hub 80 having the neck 84 into the opening 52 in the first end cap 42.

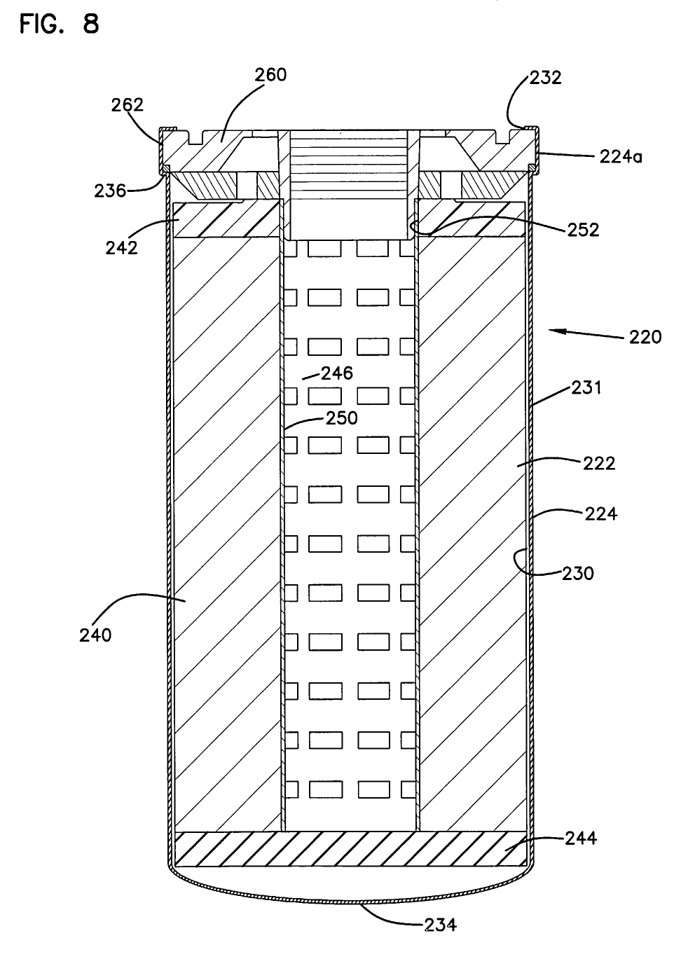

### B. Alternative Embodiments—FIGS. 8-11

In FIGS. 8-11, two alternate embodiments are described. Similarly to the embodiment shown in the previously described figures, in each of the alternate embodiments an axial seal is formed between a gasket (mounted on a baffle plate), and a projection on a housing side wall. The alternate embodiments show some of the wide applicability of principles according to the present disclosure.

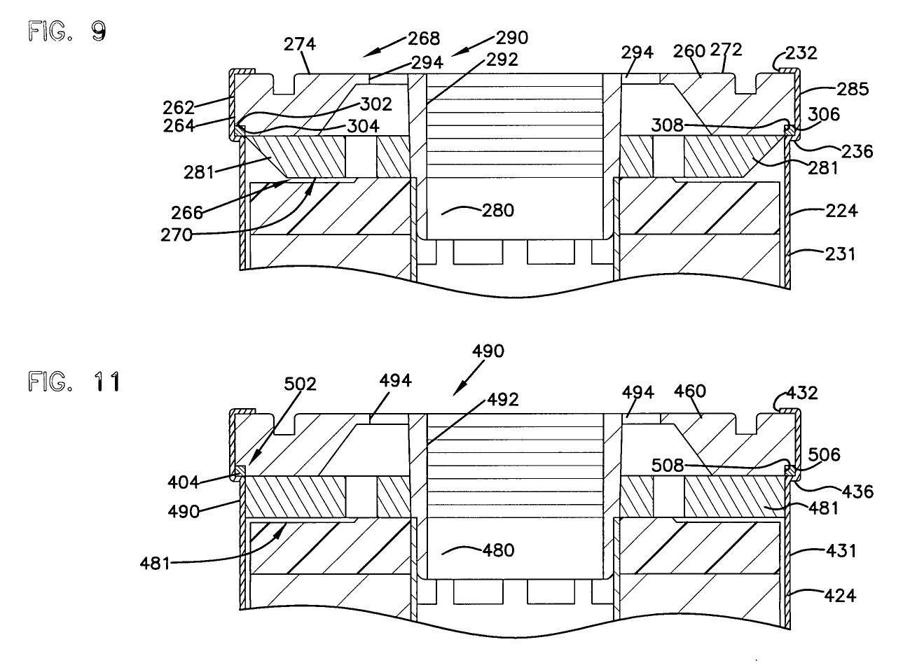

1. The Arrangement of FIGS. 8 and 9.

FIG. 8 is a cross-sectional view of a filter assembly 220 according to a second embodiment of the present disclosure. FIG. 8 in general has analogous features to FIG. 4, as follows. Referring to FIG. 8, filter assembly 220 includes a filter cartridge 222 operably oriented within can 224. The filter can 224 has an interior volume 230 designed to accept the filter cartridge 222 therein. The filter can 224 generally defines a surrounding wall 231 defining an open first end 232 and a closed second end 234. Can 224 may be analogous to can 24 described above, except for detail as characterized below.

Instead of merely having a bead projection analogous to bead 36, FIG. 4, the can wall 231 includes, as an inner circumferential projection or shelf, i.e., as an axial seal surface, a step 236. The step 236 is radially continuous and cooperates with other portions of the filter assembly 220, to seal the filter cartridge 222 there within. In preferred embodiments, the step 236 is adjacent to, and spaced from, the open end 232, and, circumscribes the interior of the can, along can wall 231. The shelf 236 (sometimes referred as an axial seal surface) separates the wall 231 into two regions of different internal size or diameter, a larger region above the shelf 236, adjacent end 232, and a smaller region below the shelf 236, adjacent closed end 234. In preferred arrangements, the shelf 236 extends a radial distance of about 0.5-5 mm into the interior 230 from an outer most portion 224a of the can 224.

The filter cartridge 222 is located inside the interior volume 230 and includes filtering material 240 for removal of contaminants. The filtering material 240 extends from and is potted within, opposite end caps 242, 244. The filter material 240 defines open interior volume 246. The filter material may be analogous to filter material 40, discussed above.

A perforated tubular inner liner 250 can be used inside the cartridge 222.

The first end cap 242 is an open end cap and includes an aperture opening 252 therein. The opening 252 can be analogous to opening 52, discussed above.

Baffle plate 260, FIG. 9, is received within can 224. The baffle plate 260 is secured across the open end 232 of the can 224. Analogous to baffle plate 60 above, baffle plate 260 conveys filtered liquid from the filter assembly 220 and provides a barrier that prevents the bypass of unfiltered liquid around the filter material 240. The baffle plate 260 includes an outer peripheral edge 262, that forms an outer circumferential sidewall 264 of baffle plate 260. The sidewall 264 is also an outer radial surface of the baffle plate 260. The baffle plate 260 includes first and second axial sides 266, 268, which correspond to a bottom end surface 270 and top end surface 272, respectively. The top end surface 272 corresponds to a top face 274. The outer peripheral sidewall 264 generally extends between the first axial side 266 and second axial side 268.

The baffle plate 260 includes fluid flow aperture arrangement 290, analogous to arrangement 90 described above, with central aperture 292 and annular apertures 294.

Baffle plate 260 includes a hub 280 analogous to plate 60; and, a fin arrangement 281 analogous to, but modified from, fin arrangement 81.

In FIG. 9, the baffle plate 260 of FIG. 8 is depicted with a gasket 304 thereon. The gasket 304 may be analogous to gasket 104, discussed above.

The baffle plate 260 includes a gasket seat 302, for holding gasket 304 in place. The gasket seat 302 includes an axial seat surface 306 for supporting the gasket 304 in an axial direction. The seat 302 also includes a radial seat surface 308. The radial seal surface 308 is depicted in this embodiment as being generally normal or perpendicular to axial seat surface 306. The seat 302 may be generally analogous to seat 102, described above.

Referring to FIG. 9, the axial seal occurs between the gasket 304 and an interior of projection 236, as shown, with end 232 of the can 224 folded over the baffle plate 260. An interference fit between the baffle plate 260 and the can wall 231 in region 285, to inhibit relative rotation between plate 260 and can 224, can be provided by having projections on the baffle plate extend into wall section 285, or by having wall section 285 extend into recesses in the baffle plate 260. Either is useable, or a combination of both can be used.

Still referring to FIG. 9, fins 281 are configured to retract out of engagement with wall 231 below shelf 236, for convenience.

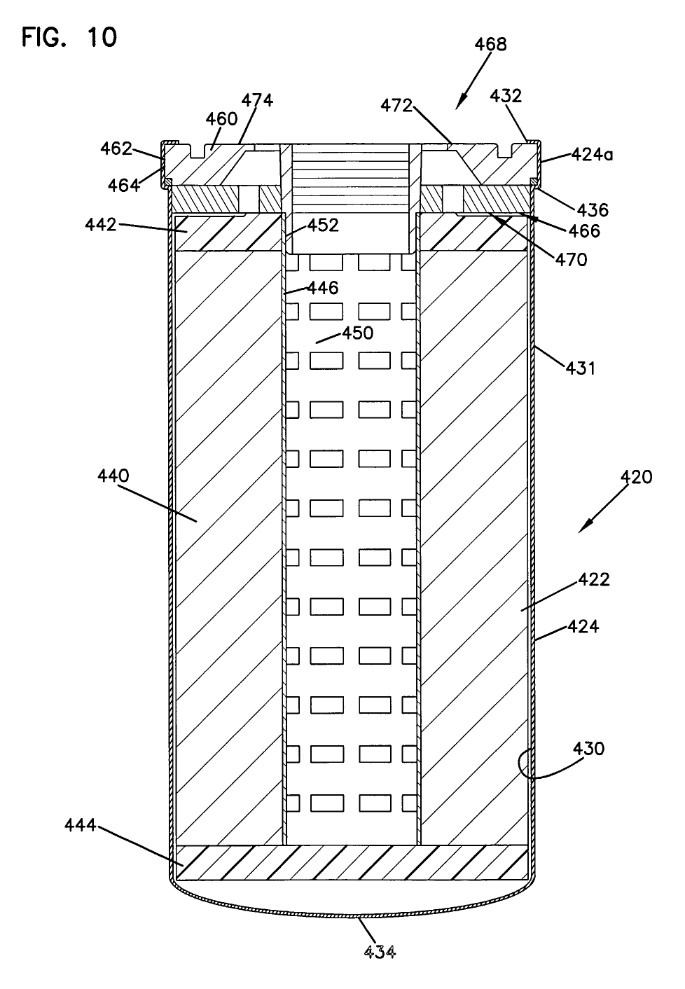

2. The Embodiment of FIGS. 10 and 11.

FIG. 10 is a cross-sectional view of a filter assembly according to a second embodiment of the present disclosure. FIG. 10 in general has analogous features to the embodiments of FIGS. 4 and 8, as follows. Referring to FIG. 10, filter assembly 420 includes a filter cartridge 422 operably oriented within can 424. The filter can 424 has an interior volume 430 designed to accept the filter cartridge 422 therein. The filter can 424 generally defines a surrounding wall 431 defining an open first end 432 and a closed second end 434. Can 424 may be analogous to can 224 described above.

Analogously to can 224, FIG. 8, the can wall 431 includes an inner circumferential projection shelf or step 436. The step 436 cooperates with other portions of the filter assembly 420, to seal the filter cartridge 422 there within. In preferred embodiments, the step 436 is adjacent to and spaced from the open end 432 and circumscribes the open end 432. In preferred arrangements, the shelf 436 extends a radial distance of about 0.5-5 mm into the interior 430 from an outer most portion 424a of the can 424.

The filter cartridge 422 is located inside the interior volume 430 and includes filtering material 440 for removal of contaminants. The filtering material 440 extends from and is potted within, opposite end caps 442, 444. The filter material 440 defines open interior volume 446. The filter material may be analogous to filter material 40, discussed above.

A perforated tubular inner liner 450 can be used inside the cartridge 422.

The first end cap 442 is an open end cap and includes an aperture opening 452 therein. The opening 452 can be analogous to opening 52, discussed above.

Baffle plate 460 is received within can 424. The baffle plate 460 is secured across the open end 432 of the can 424. Analogous to baffle plate 60 above, baffle plate 460 conveys filtered liquid from the filter assembly 420 and provides a barrier that prevents the bypass of unfiltered liquid around the filter material 440. The baffle plate 460 includes an outer peripheral edge 462, that forms an outer circumferential sidewall 464 of baffle plate 460. The sidewall 464 is also an outer radial surface of the baffle plate 460. The baffle plate 460 includes first and second axial sides 466, 468, which correspond to a bottom end surface 470 and top end surface 472, respectively. The top end surface 472 corresponds to a top face 474. The outer peripheral sidewall 464 generally extends between the first axial side 466 and second axial side 468.

Referring now to FIG. 11, the baffle plate 460 includes fluid flow aperture arrangement 490, analogous to arrangement 90 described above, with central aperture 492 and annular apertures 494.

Baffle plate 460 includes a hub 480 analogous to plate 60; and, fin arrangement 481 analogous to fin arrangement 81.

In FIG. 11, the baffle plate 460 of FIG. 10 is depicted with a gasket 404 thereon. The gasket 404 may be analogous to gasket 104, discussed above.

The baffle plate 460 includes a gasket seat 502, for holding gasket 504 in place. The gasket seat 502 includes an axial seat surface 506 for supporting the gasket 504 in an axial direction. The seat 502 also includes a radial seat surface 508. The radial seal surface 508 is depicted in this embodiment as being generally normal or perpendicular to axial seat surface 506. The seat 502 may be generally analogous to seat 502, described above.

Referring to FIG. 11, the axial seal occurs between the gasket 504 and an aside of projection 236, as shown, with end 232 of the can 224 folded over the baffle plate 460. An interference fit between the baffle plate 460 and the can wall 490, to prevent rotation, can be provided by having fins 481 on the baffle plate 460 extend into wall section 490, or by having wall section 490 extend into recesses in plate 460. Either or a combination of both can be used.

1. A filter arrangement comprising:
(a) a housing arrangement comprising:
(i) a can including a can wall defining an open end and an interior volume;
(A) the can wall including an internal axial seal surface;
(ii) a baffle plate oriented to cover the open end of the can wall; the baffle plate having an outer peripheral side wall;
(A) the baffle plate defining a fluid flow aperture arrangement to permit fluid flow communication with the interior volume of the can; and,
(B) the outer peripheral side wall defining a gasket seat; and
(iii) a gasket operably mounted within the gasket seat and positioned to seal against the internal axial seal surface of the can to form an axial seal between the can and the baffle plate;
(b) a filter cartridge operably mounted within the can interior volume.

2. A filter arrangement according to claim 1 wherein:
(a) the gasket seat includes an axial seat surface and a radial seat surface normal to the axial seat surface.

3. A filter arrangement according to claim 2 wherein:
(a) the radial seat surface has a first end intersecting the axial seat surface and an opposite second end; and, (b) the gasket seat is wall-free adjacent to the second end of the radial seat surface;
(i) the gasket being operably mounted within the gasket seat positioned against the axial seat surface and against the radial seat surface.

4. A filter arrangement according to claim 3 wherein:
(a) the baffle plate has first and second, opposite, axial sides and further includes:
(i) a central hub with a hub neck projecting from the first axial side; and
(ii) a plurality of fins projecting from the first axial side; and,
(b) the fluid flow aperture arrangement includes a central aperture circumscribed by the hub neck.

5. A filter arrangement according to claim 4 wherein:
(a) at least some fins of the plurality of fins each have a free end that is adjacent to the second end of the radial seat surface to trap the gasket in the gasket seat.

6. A filter arrangement according to claim 4 wherein:
(a) the second axial side of the baffle plate includes a groove to hold a face sealing member;
(b) the hub neck defines a threaded region; and
(c) the fluid flow aperture arrangement includes a plurality of apertures disposed around the central aperture.

7. A filter arrangement according to claim 4 wherein:
(a) at least some of the fins are pressed against the can wall.

8. A filter arrangement according to claim 1 wherein:
(a) the gasket comprises a lathe cut gasket.

9. A filter arrangement according to claim 1 wherein:
(a) the housing internal axial seal surface comprises a portion of a bead in the can wall.

10. A filter arrangement according to any claim 1 wherein:
(a) the housing internal axial seal surfaces comprise a step in the can wall between side wall regions of different internal size.

11. A filter arrangement according to claim 1 wherein:
(a) the can wall includes an end fold defining the open end of the can; the end fold being oriented against the second axial side of the baffle plate.

12. A filter arrangement according to claim 1 wherein:
(a) the filter cartridge includes a region of filter media extending between a first end cap and a second end cap;
(i) the first end cap including an open aperture.

13. A filter arrangement according to claim 1 wherein:
(a) the filter media includes pleated media forming a cylinder.

14. A method for assembling a filter arrangement; the method comprising:
(a) inserting a filter cartridge through an open end and into an interior volume of a can having a side wall;
(b) orienting a baffle plate, having a gasket thereon, to cover the open end of the can;
(i) the baffle plate having opposite axial surfaces and a baffle plate sidewall extending between the opposite axial surfaces; and,
(ii) the gasket being mounted on the baffle plate sidewall; and
(c) forming an axial seal by pressing together the gasket and an axial seal surface in the side wall of the can.

15. A method according to claim 14 further including:
(a) bending an end of the can over the baffle plate to press against the baffle plate.

16. A method according to claim 14 wherein:
(a) the step of orienting a baffle plate includes inserting a central hub on the baffle plate to project into an open end cap of the filter cartridge.

17. A method according to claim 16 wherein:
(a) the baffle plate includes a fin arrangement extending from the central hub; and
(b) the step of orienting a baffle plate includes providing a pressing engagement between the fin arrangement and the can.

18. A method according to claim 17 including:
(a) forming the internal axial seal surface in the can before the step of orienting the baffle plate to cover the open end of the can.
